(19) United States
(12) Patent Application Publication
(10) Pub. No.: US 2025/0013779 A1
(43) Pub. Date: Jan. 9, 2025

(54) System and method to evaluate encrypted data

(71) Applicant: Bank of America Corporation, Charlotte, NC (US)

(72) Inventors: Shailendra Singh, Maharashtra (IN); Saurabh Gupta, Dwarka (IN)

(21) Appl. No.: 18/347,830

(22) Filed: Jul. 6, 2023

(51) Int. Cl. G06F 21/62; G06F 21/55; H04L 9/00

(52) U.S. Cl. CPC G06F 21/6245; G06F 21/55; H04L 9/008

(57) ABSTRACT

An apparatus may be configured to evaluate encrypted data. The apparatus may comprise a memory communicatively coupled to a processor. The memory may be configured to store an asset roster. The processor may be configured to monitor user device communication at a user device, homomorphically encrypt the user device communication as encrypted user device communication, and the processor may identify a caller of interest in communication with the user device by evaluating the encrypted user device communication. Further, the processor may be configured to determine that the asset roster comprises an asset identifier associated with the caller of interest, identify cyphertext words from the encrypted user device communication, and in response to evaluating the cyphertext words, determine that the caller of interest is an attacker attempting to obtain sensitive information associated with the user device based at least in part the predefined phrases identified in the encrypted user device communication.

### TECHNICAL FIELD

The present disclosure relates generally to operation of a system configured to encrypt data in accordance with one or more security policies, and more specifically to a system and method to evaluate encrypted data.

### BACKGROUND

In operations of user devices, users may receive fraudulent calls from bad actors pretending to be assets associated with a trusted organization (e.g., a club, a company, or a team in which the user has a membership or account). These bad actors may attempt to steal sensitive data from the user by providing prompts and conversational phrases that the user may associate with the trusted organization. The bad actors may present themselves to be associated with the trusted organization by spoofing the trusted organization's numbers in the user device during a telephonic conversation. The user may be unable to identify that a bad actor is impersonating a member of the trusted organization.

### SUMMARY OF THE DISCLOSURE

In one or more embodiments, a system and a method to evaluate encrypted data received and transmitted at a user device. In particular, the system and the method may be configured to encrypt data exchanged by a user and a caller and evaluate the encrypted data to determine whether the caller is an attacker performing a fraudulent call seeking to obtain sensitive information from the user. The system and the method may prevent the user from being trapped into fraudulent calls. In some embodiments, the system and the method intercept conversation at the user device and stop transfers of voice signals between the user and the attacker by dynamically identifying callers attempting to impersonate a member of a trusted organization (e.g., a club, a company, or a team in which the user has a membership or account).

In one or more embodiments, the system and the method described herein are integrated into a practical application of reducing or preventing exposure to fraudulent callers. For example, in an event that a user device receives a call from a fraudulent caller, the system and the method may determine that the user device received a call from a fraudulent caller without parsing language from the call. In this regard, a user operating the user device may be assured that any interactions during the call are protected if the system and the method do not generate an alert for the user device. As a result, the system and the method further provide data security by protecting user's data over outgoing/incoming communications in the user device.

In one or more embodiments, the system and method are directed to improvements in computer systems. Specifically, the system and the method reduce processor and memory usage in user devices by preventing or eliminating fraudulent calls in the first data exchange network. In particular, the system and the method reduce processor and memory usage by enabling the user device to deny communications involving fraudulent callers during calls.

In one or more embodiments, the system and the method may be performed by an apparatus, such as the server. Further, the system may be a security system, that comprises the apparatus. In addition, the system and the method may be performed as part of a process performed by the apparatus. As a non-limiting example, the apparatus may comprise a memory and a processor communicatively coupled to one another. The memory may be configured to store a classification and regression tree (CART) comprising one or more sensitive word predictions. Each sensitive word prediction may be a word that is expected to be found in the user device communications. The memory may be configured to store directed acyclic graphs comprising one or more predefined phrases representative of expected conversations between a user device of the user devices and at least one caller of interest and an asset roster that lists one or more assets associated with the apparatus. The processor may be communicatively coupled to the memory and configured to monitor user device communication at the user device, homomorphically encrypt the user device communication as encrypted user device communication, obtain sensitive word predictions from the CART, and determine whether the encrypted user device communication comprises the sensitive word predictions. Further, the processor may be configured to, in response to determining that the encrypted user device communication comprises the sensitive word predictions, and identify a caller of interest in communication with the user device. The processor may be configured to determine whether the asset roster comprises an asset identifier associated with the caller of interest. The processor may be configured to, in response to determining that the asset roster is missing the asset identifier, obtain predefined phrases from the directed acyclic graphs. Additionally, the processor may be configured to identify cyphertext words from the encrypted user device communication, compare the predefined phrases to the cyphertext words, and in response to determining that the predefined phases match the cyphertext words, determine that the caller of interest attempts to obtain sensitive information associated with the user device based at least in part the predefined phrases identified in the encrypted user device communication. In response to determining that the caller of interest attempts to obtain the sensitive information, the processor may be configured to generate an alert to the user device indicating that the caller of interest is an attacker.

Certain embodiments of this disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an example system in accordance with one or more embodiments;

FIG. 2 illustrates an example operational flow performed by the system of FIG. 1 in accordance with one or more embodiments; and

FIG. 3 illustrates an example flowchart of a method to evaluate encrypted data in accordance with one or more embodiments.

### DETAILED DESCRIPTION

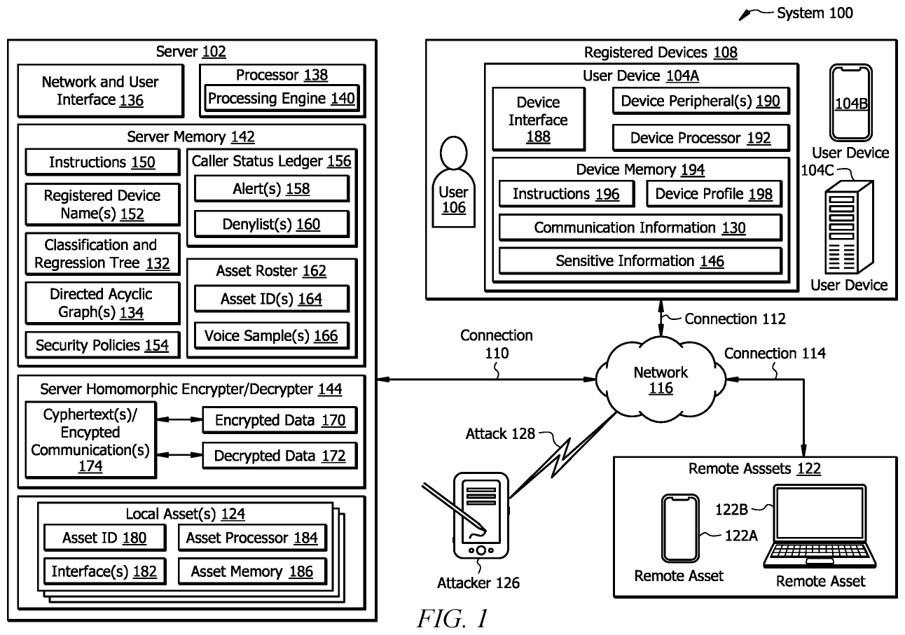

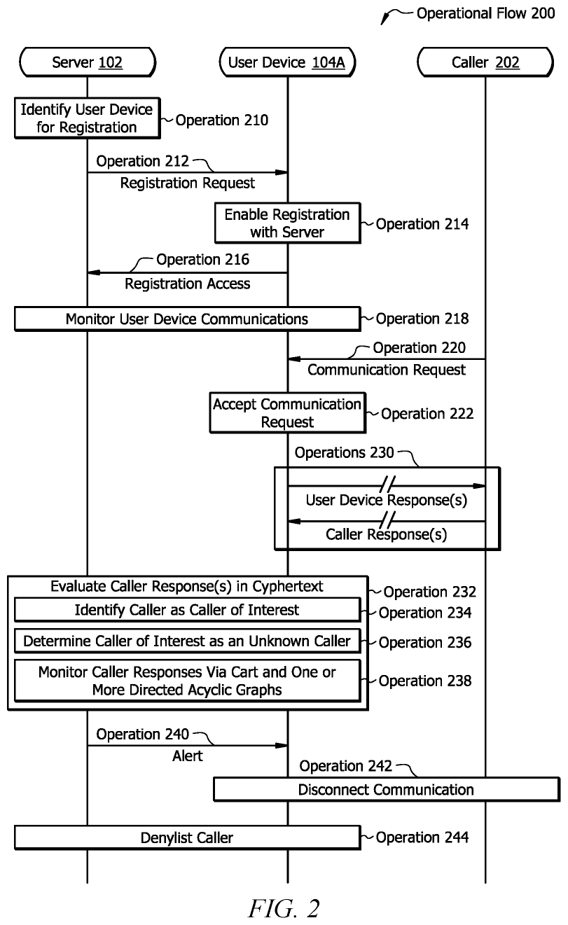

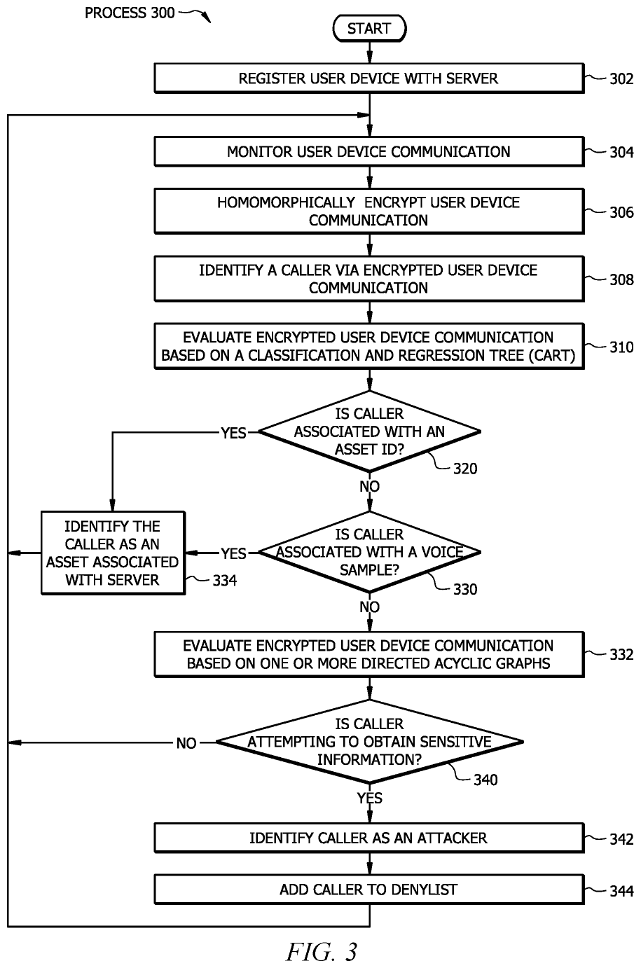

As described above, this disclosure provides various systems and methods to evaluate data encrypted in accordance with one or more security policies. FIG. 1 illustrates a system 100 in which a server 102 (e.g., an apparatus) is configured to evaluate encrypted data in communications of one or more user devices 104A-104C. FIG. 2 illustrates an operational flow 200 performed by the system 100 of FIG. 1. FIG. 3 illustrates a process 300 to perform the operational flow 200 of FIG. 2.

### System Overview

FIG. 1 illustrates a system 100 configured to evaluate encrypted data in accordance with one or more embodiments. In the system 100 of FIG. 1, a server 102 monitors one or more operations performed by one or more users (e.g., user 106) operating one or more user devices 104A-104C (collectively, user devices 104) of a group of registered devices 108 and identifies at least one operation in a first user device 104A that triggers monitoring of homomorphically encrypted information. In FIG. 1, the server 102 is communicatively coupled to multiple user devices 104 via one or more communication links (e.g., established via a connection 110, a connection 112, and/or a connection 114) and/or a network 116. While FIG. 1 shows the server 102 connected via the connection 110, the connection 112, and the network 116 to the registered devices, the server 102 may be communicatively coupled to each of the user devices 104 directly or indirectly via one or more additional electronic devices (e.g., routers, gateways, and the like). Further, the server 102 is communicatively coupled to one or more remote assets 120 comprising a remote asset 122A and a remote asset 122B (collectively, remote assets 122). While FIG. 1 shows the server 102 connected via the network 116 to the registered devices 108, the server 102 may be communicatively coupled to each of the user devices 104 directly or indirectly via one or more additional electronic devices (e.g., routers, gateways, and the like).

In one or more embodiments, the server 102 is configured to monitor multiple electronic operations of the user devices 104 over a predetermined amount of time. In reference to user device 104A as a non-limiting example, the electronic operations may comprise input and output communications received and transmitted by the user device 104A, respectively. The server 102 may be configured to identify an electronic operation that triggers a review of outgoing/incoming information between the user device 104A and at least one communication device (one of the remote assets 122, one or the local assets 124, or an attacker 126 via an attack 128) with the user device 104A. In one example, a trigger electronic operation may be an attempt by the user device 104A to receive or transmit a specific network communication (e.g., a call, a video conference, and the like) via the network 116. In some embodiments, the trigger electronic operations may be referred to as communication information 130.

In one or more embodiments, the server 102 is configured to monitor the communication information 130 of the user device 104A over the predetermined amount of time. In reference to the user device 104A as a non-limiting example, the server 102 may be configured to homomorphically encrypt the communication information 130. The server 102 may determine that the communication information 130 comprises a caller of interest. In turn, the server 102 may evaluate the homomorphically encrypted communication information 130 (e.g., encrypted user device communication) in accordance with a classification and regression tree (CART) 132 and one or more directed acyclic graphs 134. One or more results of the evaluations may indicate whether the communication information 130 comprises communications between the user device 104A and at least one of the assets (e.g., the remote assets 122 and the local assets 124) or the user device 104A and the attacker 126. If the communication information 130 comprises communications between the user device 104A and at least one of the assets (e.g., the remote assets 122 and the local assets 124), the server 102 may enable the communications to continue. If the communication information 130 comprises communications between the user device 104A and the attacker 126, the server 102 may completely or partially disable the communications to continue. The server 102 may be configured to generate one or more warnings for the user device 104A indicating that the communication information 130 comprises communications with the attacker 126.

### System Components

### Server

The server 102 is generally any device that is configured to process data and communicate with computing devices (e.g., user devices 104, remote assets 122, or local assets 124), databases, systems, and the like, via one or more interfaces (i.e., network and user interface 136). The server 102 may comprise a processor 138 that is generally configured to oversee operations of a processing engine 140. The operations of the processing engine 140 are described further below in conjunction with the system 100 described in FIG. 1, the operational flow 200 in FIG. 2, and the process 300 described in FIG. 3.

The server 102 comprises the processor 138 communicatively coupled with the network and user interface 136, a server memory 142, a server homomorphic encrypter/decrypter 144 configured to encrypt/decrypt the communication information 130 and sensitive information 146, and the local assets 124. The server 102 may be configured as shown, or in any other configuration.

In one or more embodiments, the network and user interface 136 may be any suitable hardware and/or software to facilitate any suitable type of wireless and/or wired connection. These connections may include, but not be limited to, all or a portion of network connections coupled to the Internet, an Intranet, a private network, a public network, a peer-to-peer network, the public switched telephone network, a cellular network, a local area network (LAN), a metropolitan area network (MAN), a wide area network (WAN), and a satellite network. The network and user interface 136 may be configured to support any suitable type of communication protocol as would be appreciated by one of ordinary skill in the art.

In one or more embodiments, the network and user interface 136 may be configured to enable wired and/or wireless communications. The network and user interface 136 may be configured to communicate data between the server 102 and other user devices (i.e., the user devices 104), the remote assets 122, systems, or domain(s) via the network 116. For example, the network and user interface 136 may comprise a WIFI interface, a LAN interface, a WAN interface, a modem, a switch, or a router. The processor 138 may be configured to send and receive data using the network and user interface 136. The network and user interface 136 may be configured to use any suitable type of communication protocol.

The processor 138 comprises one or more processors communicatively coupled to the server memory 142. The processor 138 may be any electronic circuitry, including, but not limited to, state machines, one or more central processing unit (CPU) chips, logic units, cores (e.g., a multi-core processor), field-programmable gate arrays (FPGAs), application-specific integrated circuits (ASICs), or digital signal processors (DSPs). The processor 138 may be a programmable logic device, a microcontroller, a microprocessor, or any suitable combination of the preceding. The one or more processors 138 are configured to process data and may be implemented in hardware or software executed by hardware. For example, the processor 138 may be 8-bit, 16-bit, 32-bit, 64-bit or of any other suitable architecture. The processor 138 may include an arithmetic logic unit (ALU) for performing arithmetic and logic operations, processor registers that supply operands to the ALU and store the results of ALU operations, and a control unit that fetches instructions 150 from the server memory 142 and executes them by directing the coordinated operations of the ALU, registers and other components. In this regard, the one or more processors 138 are configured to execute various instructions. For example, the one or more processors 138 are configured to execute the instructions 150 to implement the functions disclosed herein, such as some or all of those described with respect to FIGS. 1-3. In some embodiments, the functions described herein are implemented using logic units, FPGAs, ASICs, DSPs, or any other suitable hardware or electronic circuitry.

The server memory 142 may be volatile or non-volatile and may comprise a read-only memory (ROM), random-access memory (RAM), ternary content-addressable memory (TCAM), dynamic random-access memory (DRAM), and static random-access memory (SRAM). The server memory 142 may be implemented using one or more disks, tape drives, solid-state drives, and/or the like. The server memory 142 is operable to store the instructions 150, multiple registered device names 152 corresponding to names of one or more of the registered devices 108, the CART 132, the directed acyclic graphs 134, one or more security policies 154, a caller status ledger 156 comprising one or more alerts 158 and one or more denylists 160, an asset roster 162 comprising one or more asset identifiers (IDs) and one or more voice samples 166, and/or any other data or instructions. The instructions 150 may comprise any suitable set of instructions, logic, rules, or code operable to execute the processor 138.

In some embodiments, the CART 132 and the directed acyclic graphs 134 is configured to enable the server 102 to monitor and intercept homomorphically encrypted the communication information 130, before a caller of interest is capable of interacting with the registered devices 108. The server 102 may be configured to analyze the encrypted communication information 130. In other embodiments, the CART 132 is a predictive model repository comprising one or more sensitive word predictions that is configured to be dynamically updated in accordance with the one or more security policies 154. In yet other embodiments, each of the directed acyclic graphs 134 comprise one or more predefined phrases representative of expected conversations. In particular, the directed acyclic graphs 134 may comprise one or more branching sequences of one or more predefined phrases that represent multiple expected communication requests from a caller and multiple communication responses to any of the user devices 104. The CART 132 and the directed acyclic graphs 134 may be refined and improved over time via Artificial Intelligence (AI) and Machine Learning (ML) algorithms. The server 102 may be configured to improve the AI and ML algorithms by providing positive or negative feedback in response to a quality of the alerts 158 generated.

In one or more embodiments, the registered device names 152 may be names of the user devices 104 in the registered devices 108. The registered device names 152 may be a string of numbers, alphanumeric characters, one or more words or phrases, one or more letters, and/or symbols. The security policies 154 may comprise one or more organization rules and configurations. In FIG. 1, the security policies 154 comprise guidance provided by one or more databases indicating operations to monitor the communication information 130.

In some embodiments, the caller status ledger 156 may comprise the alerts 158 and the denylists 160 generated to the registered devices 108. In this regard, the caller status ledger 156 may associate callers to the registered devices 108 with fraudulent remarks if a caller is identified to be a fraudulent caller (e.g., the attacker 126). The alerts 158 may be warnings generated for the registered devices 108 in the form of audio feedback (e.g., the user devices 104 may sound a specific chime), visual feedback (e.g., the user devices 104 may present a specific notification), and/or tactile feedback (e.g., the user devices 104 may vibrate following a specific pattern). The denylists 160 may be lists comprising online information related to one or more identified attackers 126, spam callers, and otherwise blocked callers. The server 102 may reference the denylists 160 to inform the user device 104A that a communication request should not be received.

Further, the asset roster 162 may comprise the asset IDs 164 and the voice samples 166. The asset roster 162 associates the remote assets 122 and the local assets 124 to the server 102. The asset IDs 164 may include a combination of one or more identifiers that provide identity to the multiple assets. The asset IDs 164 may be a string of numbers, alphanumeric characters, one or more words or phrases, one or more letters, and/or symbols. The voice samples 166 may be samples of voices corresponding to agents/operators of each of the remote assets 122 and the local assets 124. The voice samples 166 may comprise one or more voice spectrograms for predefined speech samples of the agents/operators.

In some embodiments, the server homomorphic encrypter/decrypter 144 may be any combination of a hardware accelerator, a processing accelerator, signal processing circuitry (e.g., including filters, mixers, oscillators, amplifiers, and the like), or digital processing circuitry (e.g., for digital modulation as well as other digital processing). For example, the server homomorphic encrypter/decrypter 144 may be processing hardware configured to configured to allocate power, processing, and memory resources during encryption/decryption of the communication information 130. The server homomorphic encrypter/decrypter 144 may comprise encrypted data 170, decrypted data 172, and one or more cyphertexts/encrypted communications 174. The server homomorphic encrypter/decrypter 144 may be configured to perform homomorphic encryption to convert data into ciphertext (e.g., the cyphertexts/encrypted communications 174) that may be analyzed and worked on as if it were still in its original form. In some embodiments, the homomorphic encryption enables complex operations to be performed on the encrypted data 170 without compromising the encryption. In other embodiments, the server 102 does not associate the information with any of the registered user devices 108 and analyzes the cyphertexts in isolation. Plaintext is ordinary readable text, while the cyphertexts/encrypted communications 174 is transformed from plaintext using the server homomorphic encrypter/decrypter 144.

The server homomorphic encrypter/decrypter 144 may combine two or more cyphertexts/encrypted communications 174 in homomorphic encryption. For example, the server homomorphic encrypter/decrypter 144 may add or multiply together cyphertexts/encrypted communications 174 with the same results as if the encryption were performed on two plaintexts. In this regard, the server homomorphic encrypter/decrypter 144 may perform the homomorphic encryption such that the registered devices 108 are not burdened with encryption procedures. The server homomorphic encrypter/decrypter 144 may generate the encrypted data 170 and the decrypted data 172 at the server 102 or at the user devices 104. In one or more embodiments, the cyphertexts are encrypted as partially homomorphic encryption (e.g., a portion of the communication information 130 is encrypted), somewhat homomorphic encryption (e.g., the communication information 130 may be encrypted/decrypted at one end of the communication link between the server 102 and the registered devices 108), and/or fully homomorphic encryption (e.g., the communication information 130 may be encrypted/decrypted at both ends of the communication link between the server 102 and the registered devices 108.

In one or more embodiments, the server homomorphic encrypter/decrypter 144 may be additional encryption provided to the communication information 130 to evaluate whether the communication information 130 comprises the sensitive information 146. In a nonlimiting example, the server homomorphic encrypter/decrypter 144 may generate the encrypted data 170 corresponding to the communication information 130. In turn, the processor 138 may implement the CART 132 to analyze the encrypted data 170 in accordance with the security policies 154 to determine a fraud probability in the communication information 130. As described above, the security policies 154 may comprise guidelines indicating whether a sequence of predicted phrases are found in an expected order in the communication information 130. In this regard, the processor 138 may implement the CART 132 in combination with the directed acyclic graphs 134 to determine the fraud probability based at least in part upon the content of the communication information 130. At this point, the server 102 may be configured to analyze the cyphertexts/encrypted communications 174 via the CART 132. The CART 132 may start arranging the cyphertexts/encrypted communications 174 encrypted from the communication information 130 to predict a fraud conclusion based upon a potential ordering of the words spoken in the cyphertexts/encrypted communications 174. The server 102 may implement the directed acyclic graphs 134 to predict branching sequences of one or more predefined phrases that represent multiple expected communication requests from a caller and multiple communication responses to the user device 104A.

In one or more embodiments, the possibility of fraud may be determined if the sensitive information 146 is identified in the cyphertexts/encrypted communications 174 and the server 102 determines that the caller is requesting the sensitive information 146 without following the expected phrases and branching sequences from the CART 132 and the directed acyclic graphs 134. Further, the server 102 may obtain a sound sample associated with the caller, generate a spectrogram from the sound sample, and compare the spectrogram of the sound sample to the spectrograms stored in the voice samples 166. If the voice samples 166 comprise the sound sample associated with the caller, the server 102 may determine that the caller a legitimate caller.

### Assets

In one or more embodiments, the remote assets 122 and the local assets 124 are hardware components (e.g., network elements) configured to perform and manage communications with one or more of the registered devices 108. The remote assets 122 and the local assets 124 may be configured to communicate with one another, the server 102, and the registered devices 108 via the network 116. In some embodiments, the remote assets 122 may be assets located in a location remote to the server 102 and the local assets 124 may be assets located in a proximity of the server 102. For example, the server 102 and the local assets 124 may be disposed in a same predefined area (e.g., same building, organization campus, city, or the like) while the server 102 and the remote assets 122 may be disposed in different predefined areas (e.g., different buildings, cities, or the like). Referring to the local assets 124 as non-limiting examples of the contents of the remote assets 122 and the local assets 124, any asset may comprise an asset ID 180, one or more asset interfaces 182, an asset processor 184, and an asset memory 186. The asset ID 180 may be one of the asset IDs 164 included in the asset roster 162. The asset interfaces 182 may comprise screens, peripherals, speakers, microphones, and the like to enable the assets to perform one or more communication operations with the registered device s 108. In some embodiments, the asset processor 184 may perform one or more operations described in reference to the processor 138. In other embodiments, the asset memory 186 may perform one or more operations described in reference to the server memory 142. The remote assets 122 and the local assets 124 may be associated directly or indirectly with an agent or an operator that may be allowed to perform communication requests (e.g., calls) on behalf of the organization. The remote assets 122 and the local assets 124 may be configured to operate in accordance with the security policies 154 of the server 102. In one or more embodiments, while FIG. 1 shows the remote asset 122A and the remote asset 122B, the remote assets 122 may comprise less or more assets.

### Network

The network 116 facilitates communication between and amongst the various devices of the system 100. The network 116 may be any suitable network operable to facilitate communication between the server 102, the remote assets 122, and the registered devices 108 of the system 100. The network 116 may include any interconnecting system capable of transmitting audio, video, signals, data, data packets, messages, or any combination of the preceding. The network 116 may include all or a portion of a public switched telephone network (PSTN), a public or private data network, a LAN, a MAN, a WAN, a local, regional, or global communication or computer network, such as the Internet, a wireline or wireless network, an enterprise intranet, or any other suitable communication link, including combinations thereof, operable to facilitate communication between the devices.

### Registered Devices

In one or more embodiments, each of the registered devices 108 (e.g., the user devices 104A-104C) may be any computing device configured to communicate with other devices, such as the server 102, other user devices 104, databases, the remote assets 122, the local assets 124, and the like in the system 100. Each of the registered devices 108 may be configured to perform specific functions described herein and interact with one or more user devices 104A-104C. Examples of the registered devices 108 comprise, but are not limited to, a laptop, a computer, a smartphone, a tablet, a smart device, an IoT device, a simulated reality device, an augmented reality device, or any other suitable type of device.

In some embodiments, the registered devices 108 are user devices 104 that are registered with an organization associated with the server 102. The registration process may comprise accepting terms and conditions such as the security policies 154 of the server 102. As a non-limiting example, the user devices 104 may register by creating an account with the organization, evaluating the security policies 154, and accepting the security policies 154. Upon registration, the server 102 may add identification information of the registered device 108 to the registered device names 152.

The user devices 104 may be hardware configured to create, transmit, and/or receive information. The user devices 104 may be configured to receive inputs from a user (e.g., user 106), process the inputs, and generate data information or command information in response. The data information may include documents or files generated using a graphical user interface (GUI). The user devices 104 may be communicatively coupled to the server 102 via a network connection (i.e., device interface 188 and the network and user interface 136 in the server 102). The user devices 104 may transmit and receive data information, command information, or a combination of both to and from the server 102 via the device interface 188. In one or more embodiments, the user devices 104 are configured to exchange data, commands, and signaling with the server 102. In some embodiments, the user devices 104 are configured to receive at least one communication request the remote assets 122 and/or the local assets 124. The command information may include input selections/commands triggered by a user using a peripheral component or one or more device peripherals 190 (i.e., a keyboard) or an integrated input system (i.e., a touchscreen displaying the GUI). In one or more embodiments, while FIG. 1 shows the user device 104A, the user device 104B, and the user device 104C, the registered devices 108 may comprise less or more user devices 104.

In one or more embodiments, referring to the user device 104A as a non-limiting example of the user devices 104, the user device 104A may comprise the device interface 188, the one or more device peripherals 190, a device processor 192, and a device memory 194. The device interface 188 may be any suitable hardware or software (e.g., executed by hardware) to facilitate any suitable type of communication in wireless or wired connections. These connections may comprise, but not be limited to, all or a portion of network connections coupled to additional user devices 104A-104C, the server 102, the Internet, an Intranet, a private network, a public network, a peer-to-peer network, the public switched telephone network, a cellular network, a LAN, a MAN, a WAN, and a satellite network. The device interface 188 may be configured to support any suitable type of communication protocol.

In one or more embodiments, the one or more device peripherals 190 may comprise audio devices (e.g., speaker, microphones, and the like), input devices (e.g., keyboard, mouse, and the like), or any suitable electronic component that may provide a modifying or triggering input to the user device 104A. For example, the one or more device peripherals 190 may be speakers configured to release audio signals (e.g., voice signals or commands) during media playback operations. In another example, the one or more device peripherals 190 may be microphones configured to capture audio signals from the user 106. In one or more embodiments, the one or more device peripherals 190 may be configured to operate continuously, at predetermined time periods or intervals, or on-demand.

The device processor 192 may comprise one or more processors communicatively coupled to and in signal communication with the device interface 188, the device peripherals 190, and the device memory 194. The device processor 192 is any electronic circuitry, including, but not limited to, state machines, one or more CPU chips, logic units, cores (e.g., a multi-core processor), FPGAs, ASICs, or DSPs. The device processor 192 may be a programmable logic device, a microcontroller, a microprocessor, or any suitable combination of the preceding. The one or more processors in the device processor 192 are configured to process data and may be implemented in hardware or software executed by hardware. For example, the device processor 192 may be an 8-bit, a 16-bit, a 32-bit, a 64-bit, or any other suitable architecture. The device processor 192 comprises an ALU to perform arithmetic and logic operations, processor registers that supply operands to the ALU, and store the results of ALU operations, and a control unit that fetches software instructions such as device instructions 196 from the device memory 194 and executes the device instructions 196 by directing the coordinated operations of the ALU, registers, and other components via a device processing engine (not shown). The device processor 192 may be configured to execute various instructions. For example, the device processor 192 may be configured to execute the device instructions 196 to implement functions or perform operations disclosed herein, such as some or all of those described with respect to FIGS. 1-3. In some embodiments, the functions described herein are implemented using logic units, FPGAs, ASICs, DSPs, or any other suitable hardware or electronic circuitry.

In one or more embodiments, the device memory 194 comprises a device profile 198 that associates the user device 104A with the user 106. The device profile 198 may comprise IDs, names, or indicators that the user device 104A is one of the registered devices 108. The device profile 198 may indicate one or more entitlements that the user 106 is allowed to access in the server 102. One of these entitlements may indicate that the communication information 130 of the user device 104A is allowed to be evaluated to determine a possibility of fraud. The communication information 130 may be any incoming/outgoing communication data exchanged by the user device 104A. In some embodiments, the communication information comprises the sensitive information 146 that is personal information directly or indirectly associated with the user 106. For example, the sensitive information 146 may be personal information directly associated with the user 106 if the sensitive information 146 comprises a date of birth of the user 106. In another example, the sensitive information 146 may be personal information indirectly associated with the user 106 if the sensitive information 146 comprises log-in credentials to a service or account that shows the date of birth of the user 106.

### Operational Flow Overview

FIG. 2 illustrates an example operational flow 200 implemented by the system 100 of FIG. 1, in accordance with one or more embodiments. The operational flow 200 comprises communications between the server 102, the user device 104A, and a caller 202. In the operational flow 200, the server 102 determines whether the caller 202 is the one or more attackers 126. While the operational flow 200 comprises one or more operations 210-244 are shown to be performed by the server 102 and the user device 104A, additional electronic devices or components in the server 102 (e.g., the processor 138 in the server 102) or in the user device 104A (e.g., the device processor 192) may be configured to perform one or more of the operations 210-244.

In a non-limiting example, the operational flow 200 shows the server 102 evaluating encrypted data received and transmitted at the user device 104A. In particular, the operational flow 200 may be configured to encrypt communication information 130 exchanged by the user 106 and the caller 202 and evaluate the encrypted data 170 to determine whether the caller 202 is an attacker 126 performing a fraudulent call seeking to obtain the sensitive information 146 from the user 106. The operational flow 200 may prevent the user 106 from being trapped in fraudulent calls. In some embodiments, the operational flow 200 intercept conversation at the user device 104A and stop transfers of voice signals between the user device 104A and the caller 202 by dynamically identifying callers attempting to impersonate a member of a trusted organization (e.g., a club, a company, or a team in which the user has a membership or account).

The operational flow 200 may analyze cyphertexts/encrypted communications 174 and sound samples in real time to prevent fraudulent calls. The operational flow 200 may comprise implementing the CART 132 to intercept audio signals during audio calls between the user 106 and the caller 202. In some embodiments, the server 102 analyzes encrypted versions of the conversations between the user 106 and the caller 202. In an event that the server 102 identifies that the user 106 is being requested the sensitive information 146 and the caller 202 is not associated with the server 102, the server 102 may stop the conversation. The conversation may be stopped automatically or by prompting the user 106 via the user device 104A to end communications with the caller 202.

In one or more embodiments, homomorphic encryption enables analysis of encrypted data converted into a cyphertext version (e.g., the cyphertexts/encrypted communications 174) without identifying an original version. In this regard, the cyphertexts/encrypted communications 174 is evaluated in the cyphertext version and the original version is not directly identified by the server 102. The server 102 may be configured to securely identify keywords in the cyphertext version of the conversation between the user and the caller by comparing cyphertext words to triggering words configured in the CART 132. The CART 132 may be controlled via one or more directed acyclic graphs 134 configured to predict whether the caller 202 is attempting to obtain the sensitive information 146 from the user 106.

In the operational flow 200 of FIG. 2, the server 102 receives the communication information 130 from the user device 104A in the form of a voice input. The server 102 may generate the cyphertexts/encrypted communications 174 by homomorphically encrypting the data as the encrypted data 170. The server homomorphic encrypter/decrypter 144 and the processor 138 may evaluate the cyphertexts/encrypted communications 174 via the CART 132. Upon evaluating the cyphertexts/encrypted communications 174, the server 102 may determine whether a call is a fraudulent call. If the call is determined to be a fraudulent call, the server 102 may stop the call and inform the user 106 that the call is a fraudulent call via an alert 158. If the call is determined to not be a fraudulent call, the server 102 may allow the call to continue.

In one or more embodiments, the server 102 may evaluate the communication information 130 as the conversation is being performed in parallel to the conversation. In other embodiments, the server 102 may evaluate the communication information 130 acting as a middleman as the conversation is being performed. For example, the server 102 may be configured to route the responses from the caller 202 and the user 106 to one another such that any communication between the caller 202 and the user 106 is parsed by the server 102 before reaching the other.

In FIG. 2, at operation 210, the server 102 may identify the user device 104A for registration. At operation 212, the server 102 transmits a registration request to the user device 104A. The user device 104A may be configured to enable registration with the server 102 at by accepting the security policies 154. At operation 214, the user device 104A may determine enable registration with the server 102. At operation 216, a registration access may be provided by the user device 104A to the server 102. At operation 218, the server 102 may monitor user device communications (e.g., the communication information 130) at the user device 104A. As described above, the server 102 may be configured to review the user device communications in parallel as the user 106 and the caller 202 exchange communications or the server 102 may be configured to review the user device communications in series as the user 106 and the caller 202 exchange communications such that any information exchanged to/from the user device 104A is evaluated by the server 102 before it reaches its destination. At operation 220, the user device 104A receives a communication request (e.g., a call) from the caller 202. At operation 222, the user device 104A may accept the communication request from the caller (e.g., pick up the call). At operations 230, the user device 104A may transmit one or more user device responses to the caller 202 while the user device 104A may receive one or more caller responses from the caller 202. These responses may be transmitted and routed to one another at least partially via the server 102.

In one or more embodiments, operations 323-238 are performed for any of the responses in operations 230. At operation 232, the server 102 reviews the communications exchanged between the user device 104A and the caller 202 by evaluating the caller responses in cyphertext. At operation 234, the server 102 identifies the caller 202 as a caller of interest. At operation 236, the server 102 determines that the caller of interest is an unknown caller. At operation 238, the server 102 monitors caller responses via the CART 132 and the one or more directed acyclic graphs 134. At operation 240, the server 102 generates an alert 158 to the user device 104A indicating that the caller 202 is one of the one or more attackers 126.

In other embodiments, at operation 242, the user device 104A disconnects any communications with the caller 202. The operational flow 200 may conclude at the operation 244 where the server 102 and/or the user device 104A add any information associated with the caller 202 to the denylists 160.

### Example Process to Reduce Interruptions in a Network

FIG. 3 illustrates an example flowchart of a process 300 to evaluate encrypted data, in accordance with one or more embodiments. Modifications, additions, or omissions may be made to the process 300. The process 300 may comprise more, fewer, or other operations than those shown below. For example, operations may be performed in parallel or in any suitable order. While at times discussed as the server 102, any suitable system or components of the system 100 may perform one or more operations of the process 300. For example, one or more operations of the process 300 may be implemented, at least in part, in the form of instructions 150 of FIG. 1, stored on a non-transitory computer readable medium, tangible, machine-readable media (e.g., the server memory 142 of FIG. 1) that when run by one or more processors (e.g., the processor 138 of FIG. 1) may cause the one or more processors to perform operations described in operations 302-344.

In FIG. 3, the process 300 starts at operation 302, where the user device 104A is registered with the server 102. At operation 304, the server 102 monitors the user device communication information 130. At operation 306, the server 102 homomorphically encrypts the user device communication information 130 as encrypted data 170. At operation 308, the server 102 identifies the communication information 130 comprises a caller 202 by evaluating the encrypted data 170 as the cyphertexts/encrypted communications 174. At operation 310, the server 102 evaluates the cyphertexts/encrypted communications 174 based at least in part upon the CART 132.

At operation 320, the server 102 may determine whether the caller 202 is associated with one of the asset IDs 164. If the caller 202 is not associated with one of the asset IDs 164 (e.g., NO because the asset roster 162 is missing a corresponding asset ID), then the process 300 proceeds to operation 330. If the caller 202 is associated with one of the asset IDs 164 (e.g., YES), then the process 300 proceeds to operation 334. At operation 330, the server 102 may determine whether a sound sample of the caller 202 is associated with one of the voice samples 166 in the asset roster 162. If the server 102 determines that the sound sample of the caller 202 is not associated with the voice samples 166 (e.g., NO), then the process 300 proceeds to operation 332. If the server 102 determines that the sound sample of the caller 202 is associated with the voice samples 166 (e.g., YES because the sound sample matches one of the voice samples 166), then the process 300 proceeds to operation 334. At operation 332, the server 102 evaluates the cyphertexts/encrypted communications 174 based one or more of the directed acyclic graphs 134. At operation 334, the server 102 identifies the caller 202 as an asset associated with the server 102. Then, the process 300 transitions to operation 304.

At operation 340, the server 102 may determine whether the caller 202 is attempting to obtain the sensitive information 146. If the server 102 determines that the caller 202 is not attempting to obtain the sensitive information 146 (e.g., NO), then the process 300 proceeds to operation 304. At operation 304, the server 102 determines that the caller 202 is attempting to obtain the sensitive information 146 (e.g., YES), then the process 300 proceeds to operation 342.

At operation 342, the server 102 identifies the caller 202 as an attacker 126. The process 300 ends at operation 344, where the server 102 adds the caller 202 to the denylists 160. Herein, the alerts 158 may be generated to the user device 104A in the manner described in FIGS. 1 and 2. At this stage, the process 300 transitions to operation 304.

### SCOPE OF THE DISCLOSURE

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. An apparatus, comprising:
a memory, configured to store:
a classification and regression tree (CART) comprising one or more sensitive word predictions, each sensitive word prediction being a word that is expected to be found in one or more user device communications;
a plurality of directed acyclic graphs comprising one or more predefined phrases representative of expected conversations between a user device and at least one caller of interest; and
an asset roster that lists one or more assets associated with the apparatus; and
a processor communicatively coupled to the memory and configured to:
monitor a first user device communication at the user device;
homomorphically encrypt the first user device communication as first encrypted user device communication;
obtain a first plurality of sensitive word predictions from the CART;
determine whether the first encrypted user device communication comprises the first plurality of sensitive word predictions;
in response to determining that the first encrypted user device communication comprises the first plurality of sensitive word predictions, identify a first caller of interest in communication with the user device;
determine whether the asset roster comprises a first asset identifier associated with the first caller of interest;
in response to determining that the asset roster is missing the first asset identifier, obtain a first plurality of predefined phrases from the plurality of directed acyclic graphs;
identify a first plurality of cyphertext words from the first encrypted user device communication;
compare the first plurality of predefined phrases to the first plurality of cyphertext words;
in response to determining that the first plurality of predefined phrases match the first plurality of cyphertext words, determine that the first caller of interest attempts to obtain sensitive information associated with the user device based at least in part the first plurality of predefined phrases identified in the first encrypted user device communication; and
in response to determining that the first caller of interest attempts to obtain the sensitive information, generate a first alert to the user device indicating that the first caller of interest is a first attacker.

2. The apparatus of claim 1, wherein the processor is further configured to:
in response to determining that the asset roster comprises the first asset identifier, identify the first caller of interest as a first asset associated with the apparatus.

3. The apparatus of claim 2, wherein the processor is further configured to:
monitor a second user device communication at the user device;
homomorphically encrypt the second user device communication as second encrypted user device communication;
obtain a second plurality of sensitive word predictions from the CART;
determine whether the second encrypted user device communication comprises the second plurality of sensitive word predictions;
in response to determining that the second encrypted user device communication comprises the second plurality of sensitive word predictions, identify a second caller of interest in communication with the user device;
determine whether the asset roster comprises a second asset identifier associated with the second caller of interest;
in response to determining that the asset roster comprises the second asset identifier, identify the second caller of interest as a second asset associated with the apparatus;
in response to determining that the asset roster is missing the second asset identifier, obtain a second plurality of predefined phrases from the plurality of directed acyclic graphs;
identify a second plurality of cyphertext words from the second encrypted user device communication;
compare the second plurality of predefined phrases to the second plurality of cyphertext words;
in response to determining that the second plurality of predefined phrases match the second plurality of cyphertext words, determine that the second caller of interest attempts to obtain the sensitive information associated with the user device based at least in part the second plurality of predefined phrases identified in the second encrypted user device communication; and
in response to determining that the second caller of interest attempts to obtain the sensitive information, generate a second alert to the user device indicating that the second caller of interest is a second attacker.

4. The apparatus of claim 1, wherein the processor is further configured to:
in conjunction with determining that the asset roster is missing the first asset identifier, determine whether the asset roster comprises a first voice sample that matches the first caller; and
in response to determining that the asset roster comprises the first voice sample, identify the first caller as a first asset associated with the apparatus.

5. The apparatus of claim 1, wherein:
the processor is further configured to in conjunction with generating the first alert to the user device indicating that the first caller is the first attacker, add the first caller to a denylist.

6. The apparatus of claim 1, wherein:
the CART is a predictive model repository that is configured to be dynamically updated in accordance with one or more security policies.

7. The apparatus of claim 1, wherein:
each directed acyclic graph comprises one or more branching sequences of the one or more predefined phrases that represent a plurality of expected communication requests from the first caller and a plurality of communication responses to the user device.

8. The apparatus of claim 1, wherein:
the first alert is a visual notification that is displayed at the user device.

9. A method, comprising:
monitoring a first user device communication at a user device;
homomorphically encrypting the first user device communication as first encrypted user device communication;
obtaining a first plurality of sensitive word predictions from a classification and regression tree (CART), each sensitive word prediction being a word that is expected to be found in one or more user device communications;
determining whether the first encrypted user device communication comprises the first plurality of sensitive word predictions;
in response to determining that the first encrypted user device communication comprises the first plurality of sensitive word predictions, identifying a first caller of interest in communication with the user device;
determining whether an asset roster comprises a first asset identifier associated with the first caller of interest, the asset roster listing one or more assets;
in response to determining that the asset roster is missing the first asset identifier, obtaining a first plurality of predefined phrases from a plurality of directed acyclic graphs comprising one or more predefined phrases representative of expected conversations between the user device and at least one caller of interest;
identifying a first plurality of cyphertext words from the first encrypted user device communication;
comparing the first plurality of predefined phrases to the first plurality of cyphertext words;
in response to determining that the first plurality of predefined phrases match the first plurality of cyphertext words, determining that the first caller of interest attempts to obtain sensitive information associated with the user device based at least in part the first plurality of predefined phrases identified in the first encrypted user device communication; and
in response to determining that the first caller of interest attempts to obtain the sensitive information, generating a first alert to the user device indicating that the first caller of interest is a first attacker.

10. The method of claim 9, further comprising:
in response to determining that the asset roster comprises the first asset identifier, identifying the first caller of interest as a first asset.

11. The method of claim 10, further comprising:
monitoring a second user device communication at the user device;
homomorphically encrypting the second user device communication as second encrypted user device communication;
obtaining a second plurality of sensitive word predictions from the CART;
determining whether the second encrypted user device communication comprises the second plurality of sensitive word predictions;
in response to determining that the second encrypted user device communication comprises the second plurality of sensitive word predictions, identifying a second caller of interest in communication with the user device;
determining whether the asset roster comprises a second asset identifier associated with the second caller of interest;
in response to determining that the asset roster comprises the second asset identifier, identifying the second caller of interest as a second asset;
in response to determining that the asset roster is missing the second asset identifier, obtaining a second plurality of predefined phrases from the plurality of directed acyclic graphs;
identifying a second plurality of cyphertext words from the second encrypted user device communication;
comparing the second plurality of predefined phrases to the second plurality of cyphertext words;
in response to determining that the second plurality of predefined phrases match the second plurality of cyphertext words, determining that the second caller of interest attempts to obtain the sensitive information associated with the user device based at least in part the second plurality of predefined phrases identified in the second encrypted user device communication; and
in response to determining that the second caller of interest attempts to obtain the sensitive information, generating a second alert to the user device indicating that the second caller of interest is a second attacker.

12. The method of claim 9, further comprising:
in conjunction with determining that the asset roster is missing the first asset identifier, determining whether the asset roster comprises a first voice sample that matches the first caller; and
in response to determining that the asset roster comprises the first voice sample, identifying the first caller as a first asset.

13. The method of claim 9, further comprising:
in conjunction with generating the first alert to the user device indicating that the first caller is the first attacker, adding the first caller to a denylist.

14. The method of claim 9, wherein:
the CART is a predictive model repository that is configured to be dynamically updated in accordance with one or more security policies.

15. The method of claim 9, wherein:
each directed acyclic graph comprises one or more branching sequences of the one or more predefined phrases that represent a plurality of expected communication requests from the first caller and a plurality of communication responses to the user device.

16. A non-transitory computer readable medium storing instructions that when executed by a processor cause the processor to:
monitor a user device communication at a user device;
homomorphically encrypt the user device communication as encrypted user device communication;
obtain a plurality of sensitive word predictions from a classification and regression tree (CART), each sensitive word prediction being a word that is expected to be found in one or more user device communications;
determine whether the encrypted user device communication comprises the plurality of sensitive word predictions;
in response to determining that the encrypted user device communication comprises the plurality of sensitive word predictions, identify a caller of interest in communication with the user device;
determine whether an asset roster comprises an asset identifier associated with the caller of interest, the asset roster listing one or more assets;
in response to determining that the asset roster is missing the asset identifier, obtain a plurality of predefined phrases from a plurality of directed acyclic graphs comprising one or more predefined phrases representative of expected conversations between the user device and at least one caller of interest;
identify a plurality of cyphertext words from the encrypted user device communication;
compare the plurality of predefined phrases to the plurality of cyphertext words;
in response to determining that the plurality of predefined phrases match the plurality of cyphertext words, determine that the caller of interest attempts to obtain sensitive information associated with the user device based at least in part the plurality of predefined phrases identified in the encrypted user device communication; and
in response to determining that the caller of interest attempts to obtain the sensitive information, generate an alert to the user device indicating that the caller of interest is an attacker.

17. The non-transitory computer readable medium of claim 16, wherein the instructions further cause the processor to:
in response to determining that the asset roster comprises the asset identifier, identify the caller of interest as an asset.

18. The non-transitory computer readable medium of claim 16, wherein the instructions further cause the processor to:
in conjunction with determining that the asset roster is missing the asset identifier, determine whether the asset roster comprises a voice sample that matches the caller; and
in response to determining that the asset roster comprises the voice sample, identify the caller as an asset.

19. The non-transitory computer readable medium of claim 16, wherein the instructions further cause the processor to:
in conjunction with generating the alert to the user device indicating that the caller is the attacker, add the caller to a deny list.

20. The non-transitory computer readable medium of claim 16, wherein the instructions further cause the processor to:
the CART is a predictive model repository that is configured to be dynamically updated in accordance with one or more security policies; and
each directed acyclic graph comprises one or more branching sequences of the one or more predefined phrases that represent a plurality of expected communication requests from a first caller and a plurality of communication responses to the user device.
